(19) United States
(12) Patent Application Publication
(10) Pub. No.: US 2003/0163626 A1
(43) Pub. Date: Aug. 28, 2003

(54) Wireless communication module with a portable digital camera

(76) Inventors: Cheng-Tien Chen, Hsin-Chu (TW); Chiow-Yang Li, Chu-Pei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/083,525

(22) Filed: Feb. 27, 2002

(51) Int. Cl. G06F 13/14

(52) U.S. Cl. 710/305; 710/313

(57) ABSTRACT

A wireless communication module with a portable digital camera is provided. The present wireless communication module comprises a wireless adapter for communicating with a wireless communication network, a digital camera for capturing image information, a bus hub for providing ports to the wireless adapter and the digital camera, respectively and a computer host provided with a bus host controller. When the bus hub is pluggable to connect with the computer host, the bus host controller detects the wireless adapter and the digital camera both of which serving as the peripherals of the bus hub, and then loading a corresponding wireless adapter bus driver and digital camera bus driver in an operating system of the computer host. Thereby, the computer host is able to communicate with the wireless communication network via the wireless adapter.

### BACKGROUND OF THE INVENTION

1. Field of the Invention

The present invention relates to a wireless communication module, and more particularly to a wireless communication module capable of conducting a video conference.

2. Description of the Prior Art

As is known in the art, a conference, such as a PC-based conference, allows two or more conference attendees to communicate over a network with each other while sharing video images (e.g. images of attendee's faces).

An example of a known conference system is the Intel TeamStation™ System from Intel Corporation. The Intel TeamStation™ System typically includes a Pentium® II processor-based central computer with built-in networking capability, a motorized camera, a full-duplex audio system, and a high-resolution multimedia monitor. Video conferencing software is executed at the central computer to facilitate the connecting of other PCs to the central computer as well as the conferencing connection to remote sites (e.g. over a network).

The Intel TeamStation™ System is based, in part, on Intel's ProShare® program that allows users of PCs to conduct video conferences while sharing documents displayed on each monitor. The Window® 95 and Window® NT operating systems provided by Microsoft Corporation support a conferencing application such as NetMeeting 2.0 (Microsoft Corporation), allowing a user to connect his/her PC to other PCs that are running the NetMeeting software. In turn, the Intel's ProShare® program can be integrated with the NetMeeting software to connect with other PCs over a Local Area Network (LAN) or Integrated Services Digital Network (ISDN) using the appropriate communication standard (e.g. H.320 and H.323 standards, respectively).

However, when a user desires to install a conference system instead of employing the Intel TeamStation™ System from Intel Corporation, based on the consideration of the cost, the user needs to obtain equipments including a camera, a network communication adapter and an audio system etc., then integrating these equipments with a personal computer enabling executing a conferencing application. It is time-consuming and takes a lot of labor work, not meeting an economical benefit. A network communication module with a camera's function, which can be directly connected with a personal computer enabling executing a conferencing application, is thus desired.

### SUMMARY OF THE INVENTION

It is one objective of the present invention to provide a wireless communication module with a portable digital camera, which not only provides a function of wireless communication, but also encloses with a detachably digital camera that can be used as a PC camera (personal computer's camera) and a portable camera.

It is another objective of the present invention to provide a wireless communication module with a portable digital camera, which can provide functions of supporting IEEE 802.11b wireless adapter, a PC camera and portable camera.

It is a further objective of the present invention to provide a wireless communication module, which can be pluggable to connect with a personal computer enabling executing a conferencing application so that the personal computer can conduct a video conference with a remote computer via the wireless communication module.

In order to achieve the above objectives of this invention, the present invention provides a wireless communication module with a portable digital camera. The present wireless communication module comprises a wireless adapter for communicating with a wireless communication network, a digital camera for capturing image information, a bus hub for providing ports to the wireless adapter and the digital camera, respectively and a computer host provided with a bus host controller. When the bus hub is pluggable to connect with the computer host, the bus host controller detects the wireless adapter and the digital camera both of which serving as the peripherals of the bus hub, and then loading a corresponding wireless adapter bus driver and digital camera bus driver in an operating system of the computer host. Thereby, the computer host is able to communicate with the wireless communication network via the wireless adapter. Besides, the computer host can conduct a video conference with a remote computer via the wireless communication network by executing a conferencing application.

### BRIEF DESCRIPTION OF THE DRAWINGS

The objectives and features of the present invention as well as advantages thereof will become apparent from the following detailed description, considered in conjunction with the accompanying drawings.

FIG. 1 is a block diagram of a wireless communication module with a portable digital camera according to one preferred embodiment of the present invention;

FIG. 2 is a software block diagram of the preferred embodiment of FIG. 1; and

FIG. 3 is a flowchart of conducting a video conference for the preferred embodiment of FIG. 1.

### DESCRIPTION OF THE EMBODIMENTS

The present invention provides a wireless communication module with a portable digital camera, which encloses a detachably digital camera. The present wireless communication module can directly connect with a personal computer, for example a desktop computer and a notebook, to provide the personal computer with the function of wireless communication. In the other hand, when the present wireless communication module with a portable digital camera connects with the personal computer, the personal computer can conduct a video conference with a remote computer via a wireless communication network by executing a conferencing application. The digital camera enclosed in the present wireless communication module not only can be used as a PC camera (personal computer's camera), but also can be detached from the present wireless communication module for used as a portable camera. Hence, the present wireless communication module with a portable digital camera provides the functions of supporting IEEE 802.11b wireless adapter, PC camera and portable camera.

The present invention will be described as below in detailed in accordance with one preferred embodiment with reference to the accompanying drawings.

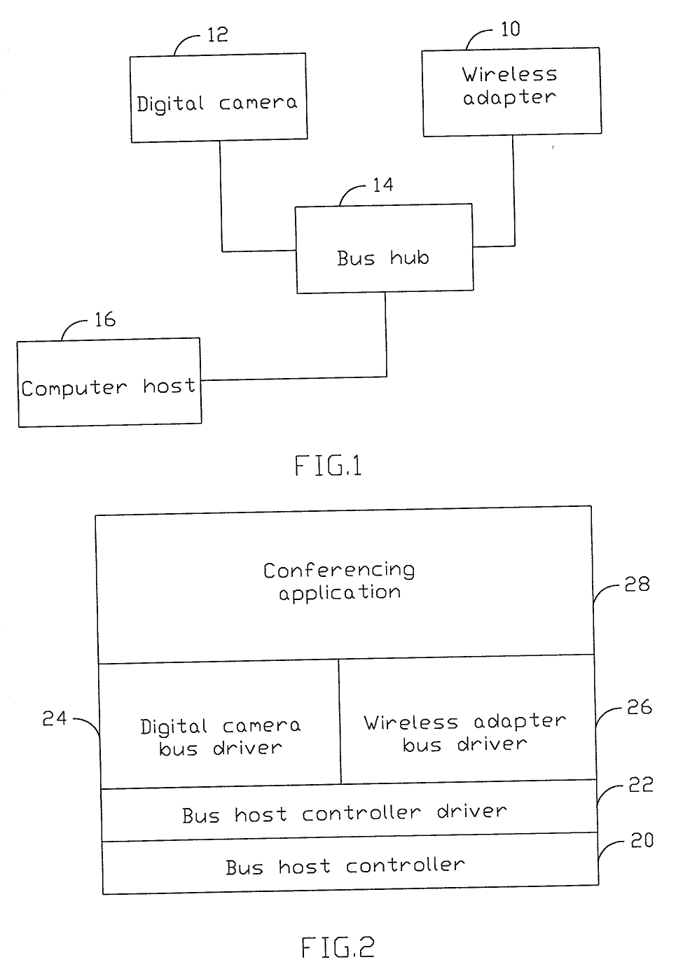

Referring to FIG. 1, which is a block diagram of the present wireless communication module with a portable camera according to the preferred embodiment of the present invention, which comprises a wireless adapter 10, a digital camera 12, a bus hub 14 and a computer host 16. The wireless adapter 10, for example a wireless universal series bus (USB) adapter, especially an IEEE 802.11b wireless USB adapter, is used for communicating with a wireless communication network. The digital camera 12 is used for capturing image information, which can be directly stored in a memory of the computer host 16 or in an internal flash memory of the digital camera 12. The bus hub 14 provides ports to the wireless adapter 10 and the digital camera 12, respectively. Hence, the digital camera 12 can be directly detached from the port of the bus hub 14, serving as a portable camera. The bus hub 14 can be a universal series bus (USB) hub, which is pluggable to connect with the computer host 16. The computer host 16 is provided with a bus host controller 20, for example a USB host controller, and a bus host controller driver 22.

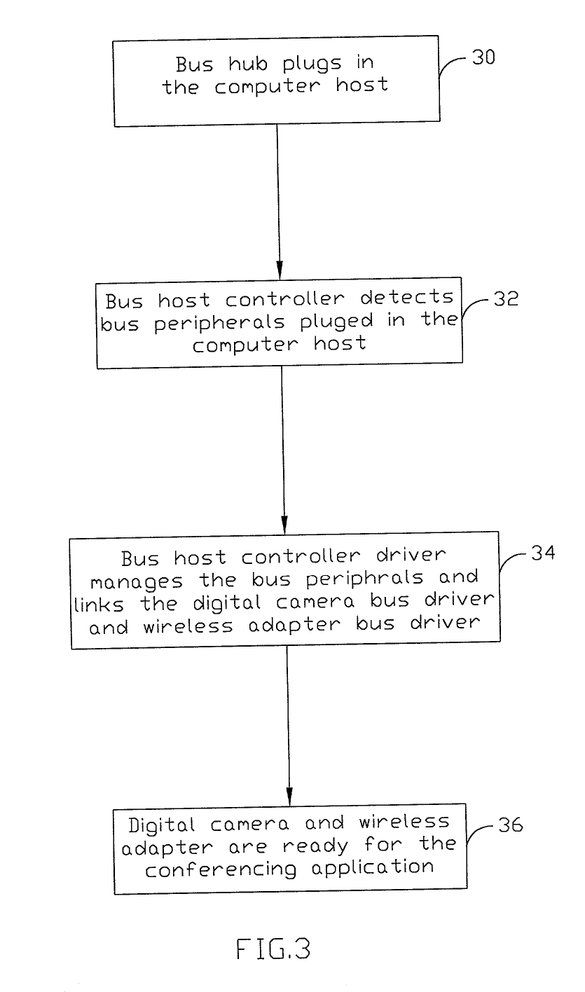

FIG. 2 and FIG. 3 respectively are a software block diagram of the preferred embodiment and a flowchart of performing a video conference for the preferred embodiment. Referring to FIG. 3, in step 30, when the bus hub 14, for example the USB hub with a plug and play property, is pluggable to connect with the computer host 16, the bus host controller 20 detects the wireless adapter 10 and the digital camera 12. While the bus hub 14 can not distinguish between the wireless adapter 10 and the digital camera 12, only thinking of the wireless adapter 10 and the digital camera 12 as the peripherals of the bus hub 14, referring to step 32. Next, in step 34, the bus host controller driver 22 manages the peripherals of the bus hub 14, and loading a corresponding digital camera bus driver 24, for example a digital camera USB driver, and a wireless adapter bus driver 26, for example a wireless adapter USB driver, in an operating system of the computer host 16. Referring to step 36, the wireless adapter 10 and the digital camera 12 link with a conferencing application 28 of the computer host 16. When the computer host 16 executes the conferencing application 28, the computer host 16 can conduct a video conference with other remote computers, one or more, sharing information displayed in each monitor including images, documents and files, etc., via the wireless adapter 10 through the wireless communication network.

The present wireless communication module with a portable digital camera can provide the computer host 16 a networking capability. When the digital camera bus driver 24 in the computer host 16 is not driven, the networking capability of the computer host 16 is not influenced. Besides, the computer host 16 can be a notebook, a user can use the present wireless communication module anywhere he goes to, not limited to a fixed location, therefore, facilitating the user's convenience.

The embodiments are only used to illustrate the present invention, not intended to limit the scope thereof. Many modifications of the embodiments can be made without departing from the spirit of the present invention.

What is claimed is:

1. A wireless communication module with a portable digital camera, comprising:
a wireless adapter for communicating with a wireless communication network;
a digital camera for capturing image information;
a bus hub for providing ports to said wireless adapter and said digital camera, respectively; and
a computer host provided with a bus host controller;
wherein when said bus hub is pluggable to connect with said computer host, said bus host controller detects said wireless adapter and said digital camera both of which serving as the peripherals of said bus hub, and then loading a corresponding wireless adapter bus driver and digital camera bus driver in an operating system of said computer host, thereby said computer host is able to communicate with said wireless communication network via said wireless adapter.

2. The wireless communication module of claim 1, wherein said wireless adapter is a wireless universal series bus (USB) adapter.

3. The wireless communication module of claim 1, wherein said wireless adapter is an IEEE 802.11b wireless USB adapter.

4. The wireless communication module of claim 1, wherein said bus hub is a universal series bus (USB) hub.

5. The wireless communication module of claim 1, wherein said computer host is a desktop computer.

6. The wireless communication module of claim 1, wherein said computer host is a notebook.

7. The wireless communication module of claim 1, wherein said digital camera is detachably connected with said wireless communication module.

8. A wireless communication module capable of conducting a video conference, comprising:
a wireless adapter for communicating with a wireless communication network;
a digital camera for capturing image information;
a bus hub for providing ports to said wireless adapter and said digital camera, respectively; and
a computer host provided with a bus host controller and serving for executing a conferencing application;
wherein when said bus hub is pluggable to connect with said computer host, said bus host controller detects said wireless adapter and said digital camera both of which serving as the peripherals of said bus hub, and then loading a corresponding wireless adapter bus driver and digital camera bus driver in an operating system of said computer host, thereby said wireless adapter and said digital camera link said conferencing application, and said computer host is able to conduct a video conference with a remote computer via said wireless communication network by executing said conferencing application.

9. The wireless communication module of claim 8, wherein said wireless adapter is a wireless universal series bus (USB) adapter.

10. The wireless communication module of claim 8, wherein said wireless adapter is an IEEE802.11b wireless USB adapter.

11. The wireless communication module of claim 8, wherein said wireless adapter is a USB hub.

12. The wireless communication module of claim 8, wherein said computer host is a desktop computer.

13. The wireless communication module of claim 8, wherein said computer host is a notebook.

14. The wireless communication module of claim 8, wherein said conferencing application is NetMeeting application software.
